(19) United States
(12) Patent Application Publication
(10) Pub. No.: US 2018/0234775 A1
(43) Pub. Date: Aug. 16, 2018

(54) METHOD FOR OPERATING A HEARING DEVICE AND HEARING DEVICE

(71) Applicant: SIVANTOS PTE. LTD., SINGAPORE (SG)

(72) Inventor: DIRK JUNIUS, MOEHRENDORF (DE)

(21) Appl. No.: 15/896,437

(22) Filed: Feb. 14, 2018

(30) Foreign Application Priority Data
Feb. 16, 2017 (DE) 10 2017 202 480.1

(51) Int. Cl. H04R 25/00

(52) U.S. Cl. CPC H04R 25/505; H04S 7/30; H04R 25/45; H04R 25/305

(57) ABSTRACT

A hearing device includes at least one microphone for generating an electrical microphone signal from an ambient sound, and an audio signal input for receiving an audio input signal, which is separate from the microphone signal. A method for operating a hearing device includes generating an output signal on the basis of the microphone signal and/or the audio input signal. In response to the receiving of the external audio input signal, depending on a decision made automatically and/or by the user in connection with the receiving of the external audio input signal, the external audio input signal is at least additionally attenuated in a predetermined band of low frequencies and used to generate the output signal.

### CROSS-REFERENCE TO RELATED APPLICATION

This application claims the benefit, under 35 U.S.C. § 119, of German Patent Application DE 10 2017 202 480.1, filed Feb. 16, 2017; the prior application is herewith incorporated by reference in its entirety.

### BACKGROUND OF THE INVENTION

### Field of the Invention

The invention relates to a method for operating a hearing device, in particular a hearing device including at least one microphone for generating an electrical microphone signal from an ambient sound, and an audio signal input for receiving an external audio input signal. The invention also relates to such a hearing device.

Hearing devices are mostly used to relay sound (“ambient sound”) detected by a microphone to the hearing system of the user of the hearing device. In particular in the case of hearing aids, after detection of the ambient sound, a microphone signal generated from the ambient sound is conditioned by using signal processing techniques. This conditioning (“signal processing”) usually takes into account a hearing loss of the particular user. For instance, different frequency bands are amplified differently (i.e. accentuated or dampened) in the signal processing in order to provide at least a certain degree of compensation for the hearing loss of the user. Filtering of distracting background sounds is usually also included. In order to output the processed microphone signal, hearing devices usually include a loudspeaker for acoustic reproduction of the processed signal. Alternatively, mechanical or electrical transducers are also used, which output the processed microphone signal to the user by using bone conduction or electrical stimulation of the inner ear.

In addition to hearing aids, the term hearing device also includes other devices that are not used, or not used solely, to compensate for hearing loss. These include, for example, headsets, headphones or so-called tinnitus maskers, which are constructed to use a (“therapeutic”) noise to mask (i.e. cover up) any ringing in the ear that the user may have.

In particular for modern hearing aids, it is also possible to feed an additional (“external”) audio input signal into the hearing device (by non-acoustic measures) and hence to output that signal independently of any acoustic detection by the microphone. An example of such an audio input signal is the “audio output” from a television set, from a stereo system or even from a reproduction system for a lecture, concert or the like. Feeding in an external audio signal separately in this way can prevent, in particular, room acoustics, quality of loudspeakers (speakers in the television set, the stereo system, etc.) from having an effect. In other words, the information contained in the audio input signal can be received practically unaltered.

Often, however, the user of the hearing device is not the only one who would like to receive the information in the audio input signal. For instance, often several people at once are watching the same television set, listening to music from the same stereo system or are attending the same lecture. Thus, in this case the audio input signal needs to be transmitted not only to the hearing device of the user but also by acoustic measures to the other people. In this situation, however, it can happen that the user of the hearing device receives the information in the audio input signal not only as an output from his or her hearing device but also by acoustic measures independently of his or her hearing device. In other words, superimposed on the acoustic output from the user's hearing device are sounds that reach the hearing system of the user by acoustic measures “past the hearing device.” That is inherently the case in particular for a so-called “open-ear” hearing device, i.e. for a hearing device having ear tips that do not make a soundproof seal in the auditory canal and/or for so-called vented hearing devices. In particular because of the different propagation speeds of airborne sound and electrical signal transmission, a time delay (i.e. a propagation time difference) often arises in that case between the output of the audio input signal and the direct acoustic acquisition of the same information from the ambient sound. One of the results thereof is a “comb filter” effect, which causes unwanted distortion of the auditory impression experienced by the user of the hearing device.

### SUMMARY OF THE INVENTION

It is accordingly an object of the invention to provide a method for operating a hearing device and a hearing device, which overcome the hereinafore-mentioned disadvantages of the heretofore-known methods and devices of this general type and which provide a hearing device having improved hearing comfort.

With the foregoing and other objects in view there is provided, in accordance with the invention, a method for operating a hearing device. This hearing device includes at least one microphone for generating an electrical microphone signal from ambient sound, and an audio signal input for receiving an audio input signal (which is preferably external, i.e. provided in particular by an audio device that is separate from the hearing device), which is separate from the microphone signal. According to the method, an output signal is generated on the basis of the microphone signal and/or the audio input signal. In addition, in response to the receiving of the external audio input signal, depending on a decision made automatically and/or by the user in connection with the receiving of the external audio input signal, the external audio input signal is at least additionally attenuated in a predetermined band of low (preferably audible “audio”) frequencies and used to generate the output signal.

The term “automatically” is understood to mean in this case and below in particular that the decision is preferably made independently by the device (i.e. by the hearing device). “In connection with the receiving of the audio input signal” is understood in this case and below in particular in the sense that the decision is preferably directly linked in time and/or causally to the receiving of the audio input signal.

The expression “at least additionally attenuated” is understood to mean in this case and below in particular that attenuation of the audio input signal on the basis of the decision made is performed “actively,” i.e. by suitable signal processing in the hearing device. In particular for the case in which the hearing device is a hearing aid, signal processing of the audio input signal, which signal processing is in particular frequency-dependent and preferably defined for a specific user on the basis of a personal hearing loss of the user of the hearing device, i.e. for instance accentuating and/or damping different frequency bands, is performed optionally irrespective of the decision made. The attenuation in the predetermined low frequency band that is performed depending on the decision made is thus carried out (only) in this case actually in addition to this personally defined hearing-loss-specific signal processing. In order to make a clearer distinction, “additional attenuation” is always used in this case and below to refer to the above-described attenuation which is dependent on the decision made in response to the receiving of the audio input signal (independent of a hearing-loss-specific signal processing).

The “and/or” conjunction is understood in this case and below in particular in the sense that the terms or features linked thereby can exist both as alternatives and in combination. Thus, for instance, in one variant the output signal can be generated from a combination of the microphone signal and the audio input signal. Alternatively, however, it is also possible to use solely the audio input signal to generate the output signal.

Preferably for the case in which, on the basis of the decision made, no additional attenuation of the audio input signal takes place in the low frequency band, the audio input signal is used substantially (i.e. if applicable, apart from the personal signal processing defined for the specific hearing loss) over its full input-side bandwidth to generate the output signal.

This means that preferably upon the receiving of the audio input signal, on the basis of the decision made, the audio input signal is used either with (preferably additional) attenuation of the low-frequency signal components or, if applicable, merely with customary signal processing defined for the specific hearing loss, in order to generate the output signal.

In the context of the additional attenuation of the audio input signal in the band of low frequencies, i.e. in particular of the low-frequency signal components, “attenuation” is understood in this case and below in the sense of true “attenuation,” in particular as a reduction of a signal level in this frequency band, or optionally also in the sense of “cutoff,” i.e. complete suppression of this frequency band. This band of low frequencies to be additionally attenuated depending on the decision, lies in particular below 1500 Hz, preferably below 1000 Hz, in this context. In an advantageous development, this low-frequency band can also be defined for a specific user, for example when the function of the hearing device in the form of a hearing aid is customized by a hearing-aid audiologist, for instance stored in a memory unit of the hearing device.

The above-described decision-based additional attenuation of low-frequency signal components of the audio input signal advantageously facilitates improved adaptation of the sound quality of the hearing device to the prevailing auditory situation and hence an improvement in the hearing comfort. In particular, the additional attenuation makes it possible to improve the sound quality especially in those cases in which, in addition to the audio input signal, the same (audio information) also reaches the hearing system of the user by acoustic measures, in particular past the hearing device. Specifically in the latter case, in particular low-frequency signal components often audibly to the user reach the hearing system of the user past the hearing device, and there affect the acoustic output from the audio input signal. In particular (for example because of interference caused in particular by propagation time differences), unwanted sound effects such as the “comb filter effect,” for instance, often arise in this case, which, despite the external audio input signal being fed into the hearing device, can produce an auditory impression that is subjectively perceived as distorted or unpleasant. Thus, advantageously a superposition of the low-frequency signal components, by virtue of the additional attenuation of the low-frequency signal components in the audio input signal, can facilitate a better sound quality for the user of the hearing device because the audio information in the low-frequency signal components is in this case (also) transmitted by acoustic measures.

In an advantageous method variant, in (preferably immediate) response to the receiving of the external audio input signal, a prompt is given to input to the hearing device the decision by the user. Thus, the receiving of the audio input signal is preferably causal to this request and to the consequently made decision. Preferably it is specifically asked in this case whether the user wants the additional attenuation of the low-frequency signal components. Optionally it is asked additionally or alternatively in this case whether the external audio input signal (or its audio information) is also audibly present (for instance as an output through television set speakers, stereo system speakers or other loudspeakers). In this process, an audible signal is output through a loudspeaker of the hearing device and/or a visual signal is output, possibly through a control unit that is separate from the hearing device (for instance a smartphone or another remote control associated with the hearing device), in order to prompt for the decision. The user hence inputs the decision accordingly, for instance through a switch or pushbutton on the hearing device itself and/or optionally through an input to the separate control unit.

The above-described decision regarding the additional attenuation is preferably directed at toggling between two “hearing programs” (i.e. in particular predetermined parameter sets), in particular stored in a memory unit of the hearing device, relating to the signal processing of the external audio input signal. In the case of the user making the decision, the user can thus personally select the signal processing that is subjectively better for him or her.

In order to increase further the convenience of using the hearing device, in particular to relieve the user of the decision over the signal processing to be performed, in an advantageous method variant, in response to the receiving of the audio input signal, the audio input signal is compared with the microphone signal (generated by the microphone). The decision to additionally attenuate the low-frequency signal components of the audio input signal is made in this case in particular if there is sufficient (or “significant”) similarity between the audio input signal and the microphone signal. This means that the low-frequency signal components of the audio input signal are additionally attenuated when the audio input signal and the microphone signal are similar (in particular to a relatively high degree). This is the case especially when the (audio) information carried by the audio input signal also reaches the hearing device by acoustic measures (i.e. as a sound signal). In particular for an open-ear hearing device (i.e. when using an ear tip that does not entirely seal the auditory canal, or for a hearing device that allows venting of the auditory canal), it is highly likely in this case that the sound in the ear of the user is affected as described above, for instance by the comb filter effect. Conversely, when there is a dissimilarity between the audio input signal and the microphone signal, preferably no additional attenuation of the low-frequency signal components accordingly takes place, because in this case it is highly likely that acoustic transmission of the information in the audio input signal is not taking place. Thus, in the latter case, if the information in the audio input signal is not transmitted acoustically past the hearing device, it is advantageously possible to prevent a loss in audio information as a result of the additional attenuation.

In an optional embodiment, the decision input by the user is also taken into account in addition to the above-described decision by the device. For example in this case, this decision by the user is given a higher priority than the decision by the device, so that the user thus has the opportunity to enable or inhibit, according to current personal preference, the additional attenuation of the audio input signal.

In a preferred method variant, in order to compare the audio input signal and the microphone signal, a correlation function, in particular a cross-correlation function, is calculated for these two signals. In other words, the audio input signal and the microphone signal are (cross-)correlated with each other.

In another preferred method variant, the similarity between the audio input signal and the microphone signal is determined from a maximum of the correlation function described above. This maximum is known to represent a measure of similarity between the signals that are correlated with one another.

In a particularly advantageous method variant, the maximum of the cross-correlation exceeding a predetermined threshold value is used as a criterion for sufficient similarity between the audio input signal and the microphone signal. This means that sufficient (significant) similarity of the two signals is ascertained if the maximum exceeds the predetermined threshold value.

In a further advantageous method variant, in the event that the audio input signal is no longer present (i.e. received), the output signal is generated (in particular solely) from the microphone signal by performing the signal processing before the time of receiving the audio input signal. In other words, the hearing device reverts to its previous signal processing. Alternatively or additionally, the hearing situation prevailing once receiving the audio input signal has ended is analyzed (in particular “classified”), and the result of the analysis is used as the basis for (“re”)adjusting the signal processing accordingly.

With the objects of the invention in view, there is also provided a hearing device which comprises at least the above-described microphone used for generating the microphone signal from the ambient sound. The hearing device also includes the audio signal input for receiving the audio input signal, which is separate from the microphone signal. In addition, the hearing device includes a signal processor, which is configured to perform the method of the type described above. The signal processor is hence configured to generate the output signal on the basis of the microphone signal and/or the audio input signal, and, in response to the receiving of the external audio input signal, depending on the decision made automatically and/or by the user, to attenuate at least additionally the low-frequency signal components of the external audio input signal and to use the same to generate the output signal. In other words, the hearing device according to the invention is operated by the method described above.

In a preferred embodiment, the signal processor is formed, at least in essence, by a microcontroller having a processor and a data storage device, in which the functions for performing the method according to the invention are programmed in the form of operating software (firmware) so that the method—possibly in interaction with the user of the hearing device—is performed automatically when the operating software is executed in the microcontroller. The signal processor alternatively includes a non-programmable electronic component, for instance an ASIC, in which the functions for performing the method according to the invention are implemented by circuitry.

In a preferred embodiment, the audio input signal is a signal that is transmitted electromagnetically, in particular wirelessly, to the hearing device. In this case, the audio signal input includes in particular an antenna for receiving the audio input signal wirelessly. For example, the antenna is an antenna of this type that is constructed for a frequency band of about 2.4 GHz.

As an alternative to the antenna described above, the audio signal input includes, for example, an audio jack socket, a phono socket or the like as a receptacle for an audio cable for wired transmission of the audio input signal.

In a further advantageous embodiment, the hearing device is constructed to be an open-ear hearing device for the user. This means that the hearing device includes in particular an open ear tip, for instance a so-called “open dome,” or an ear mold containing a vent, through which airborne sound from the surroundings can reach the eardrum of the user of the hearing device. Similarly, however, the hearing device can also be formed by a vented module that is constructed to be worn in the auditory canal. For instance in the latter case, the hearing device is known as an in-the-ear (“ITE”) hearing aid. An open-ear device of this kind helps to avoid so-called occlusion effects, which can occur if the auditory canal is sealed.

Other features which are considered as characteristic for the invention are set forth in the appended claims.

Although the invention is illustrated and described herein as embodied in a method for operating a hearing device and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a hearing device; and

FIG. 2 is a flow diagram of a method for operating the hearing device shown in FIG. 1.

### DETAILED DESCRIPTION OF THE INVENTION

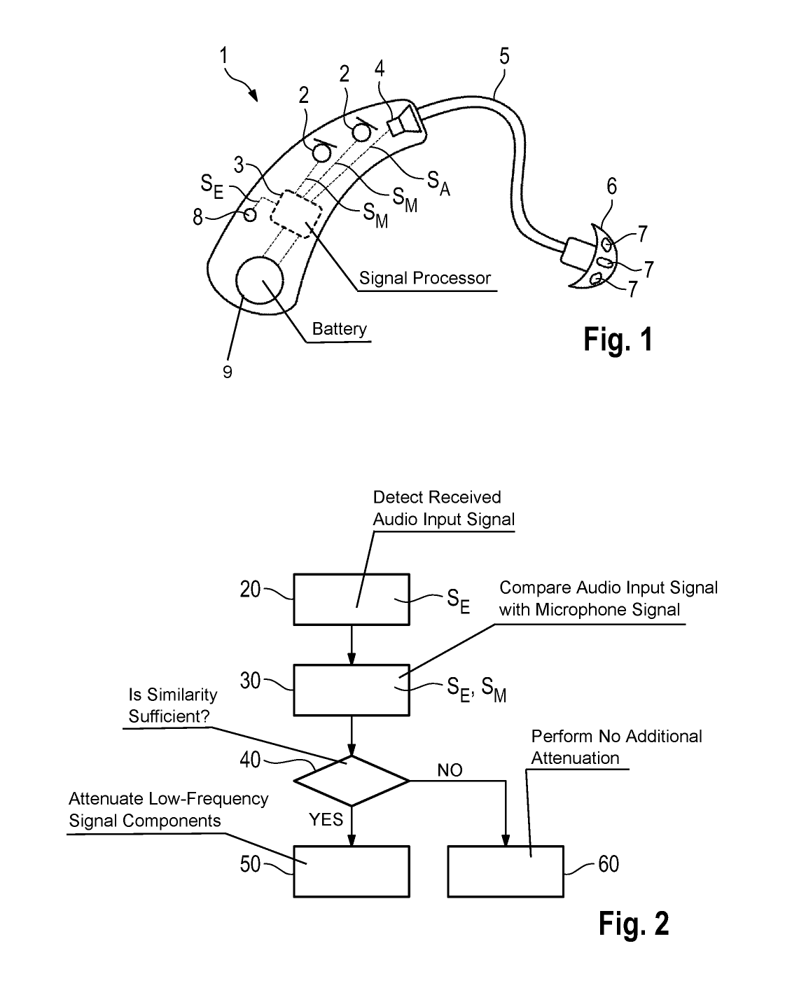

Referring now in detail to the figures of the drawings, in which corresponding parts and variables are always denoted by the same reference signs, and first, particularly, to FIG. 1 thereof, there is seen a hearing aid device (abbreviated to “hearing aid” 1) as an example of a hearing device. The hearing aid 1 includes two microphones 2, a signal processor 3 and a battery 9. The two microphones 2 are each constructed to generate a microphone signal S_{M} from an ambient sound (i.e. from sounds from the surroundings of the hearing aid 1). The signal processor 3 is constructed to amplify, attenuate, filter, etc. the individual microphone signal S_{M} or, if applicable, a combined signal produced by mixing both microphone signals S_{M}, on a frequency-selective basis according to user-specific settings (also referred to as “parameters”) by processing stored signal processing algorithms, thereby generating an output signal S_{A}. The signal processor 3 outputs the output signal to a loudspeaker 4 of the hearing aid 1. The loudspeaker 4 is constructed in this case to convert the output signal S_{A} into airborne sound. The airborne sound is then output by using a sound tube 5 and an ear tip 6, which connects the open end of this sound tube 5 to the eardrum of a user using the hearing aid 1. The ear tip 6 includes a plurality of holes 7, through which airborne sound from the surroundings of the hearing aid 1 can also reach the eardrum of the user through the auditory canal. The hearing aid 1 therefore is constructed to be an open-ear hearing device for the user.

The hearing aid 1 also includes an audio signal input 8, which is likewise connected to the signal processor 3. The audio signal input 8 serves to receive and transfer an audio input signal S_{E} to the signal processor 3. The audio input signal S_{E} is a signal that is separate from the microphone signals S_{M} and that is provided to the hearing aid 1 by an external signal source. The audio signal input 8 includes in this case an antenna (not shown in greater detail) for receiving the audio input signal S_{E} wirelessly.

For example, the audio input signal S_{E} is an audio signal from a television set that the user of the hearing aid 1 is currently watching. The audio input signal S_{E} is also referred to as a “streaming signal.” Using an audio input signal S_{E} of this type has the advantage in this case that it is possible to prevent the acoustic transmission path (for instance the loudspeakers belonging to the television set, the acoustics of the room, etc.) from affecting the sound. For the case in which the audio information in the audio input signal S_{E} is also being provided by acoustic measures for instance to other people (who are watching television together with the user), it can happen that the information in the wirelessly transmitted audio input signal S_{E} is superimposed in the ear of the user with the audio information in the acoustic output from the television set, which audio information reaches the eardrum acoustically through the holes 7 in the ear tip 6, potentially creating positive and/or negative interference. This is known to cause a degradation in the sound quality in the ear of the user.

In order to prevent this, the signal processor 3 is constructed (in software or in circuitry) to perform a method described in greater detail with reference to FIG. 2. In a first method step 20, the receiving of the (external) audio input signal S_{E} is detected through the audio signal input 8. As a result, in a second method step 30, the audio input signal S_{E} is compared with the microphone signal S_{M} (or the signal combined from the two microphone signals S_{M}) by using a cross-correlation function. In this step, a maximum of the cross-correlation function is calculated and compared with a threshold value stored in the signal processor 3. In the event that the maximum exceeds the threshold value, a sufficient (or even significant) similarity between the audio input signal S_{E} and the microphone signals S_{M} is ascertained. This indicates that it is highly likely that the television set is also outputting the information in the audio input signal S_{E} by acoustic measures. In this case, i.e. in the event of sufficient similarity, the decision is made in a decision step 40 that in a subsequent signal processing step 50, low-frequency signal components of the external audio input signal S_{E} are attenuated. This is because primarily low-frequency components from the ambient sound reach the eardrum of the user through the holes 7 and hence result in unwanted superpositions precisely in this low-frequency band.

In the event that the audio input signal S_{E} and the microphone signal S_{M} are dissimilar from each other, specifically that the maximum of the cross-correlation function does not exceed the stored threshold value, the decision is made in the decision step 40 to perform no additional attenuation of the low-frequency signal components in the audio input signal S_{E} in a subsequent signal processing step 60. In this case, the audio input signal S_{E} is used over its full bandwidth to generate the output signal S_{A}.

In an alternative or optionally additional exemplary embodiment, in the method step 30, the user of the hearing aid 1 is prompted to input into the hearing aid 1 whether or not he or she wants the above-described additional attenuation of the low-frequency signal components. Subsequently, on the basis of the decision of the user, a choice is made in the decision step 40 for signal processing according to the signal processing step 50 or 60.

In a further method variant, which is likewise described with reference to FIG. 2, in the method step 30, the user of the hearing aid 1 is prompted to state whether the information in the audio input signal S_{E} is also audibly present. Specifically, the user is meant to state in this case whether the audio output, for example from the television set, is “just” streamed to his hearing aid 1 or whether there is also an acoustic output being made through the loudspeakers of the television set. If streaming and acoustic output jointly exist, the additional attenuation according to the signal processing step 50 is then selected accordingly in the decision step 40. Otherwise, i.e. when solely the audio input signal S_{E} is being streamed, the signal processing according to the signal processing step 60 is performed.

The subject matter of the invention is not restricted to the exemplary embodiments described above. In fact a person skilled in the art can derive further embodiments of the invention from the above description. In particular, the individual features of the invention and of its embodiment variants, which features are described with reference to the various exemplary embodiments, can also be combined with one another in other ways.

The following is a summary list of reference numerals and the corresponding structure used in the above description of the invention:
1 hearing aid
2 microphone
3 signal processor
4 loudspeaker
5 sound tube
6 ear tip
7 hole
8 audio signal input
9 battery
20 method step
30 method step
40 decision step
50 signal processing step
60 signal processing step
S_{M} microphone signal
S_{E} audio input signal
S_{A} output signal

1. A method for operating a hearing device, the method comprising the following steps:
providing a hearing device including at least one microphone for generating an electrical microphone signal from an ambient sound, and an audio signal input for receiving an external audio input signal being separate from the microphone signal;
generating an output signal based on at least one of the microphone signal or the external audio input signal; and
at least additionally attenuating the external audio input signal in a predetermined band of low frequencies and using the attenuated external audio input signal to generate the output signal, in response to receiving the external audio input signal and depending on a decision made at least one of automatically or by a user in connection with receiving the external audio input signal.

2. The method according to claim 1, which further comprises giving a prompt to input the decision by the user to the hearing device in response to receiving the external audio input signal.

3. The method according to claim 1, which further comprises, in response to receiving the external audio input signal:
comparing the external audio input signal with the detected microphone signal, and
making the decision to attenuate the external audio input signal in the predetermined band of low frequencies when there is sufficient similarity between the external audio input signal and the microphone signal.

4. The method according to claim 3, which further comprises carrying out the comparison step by calculating a correlation function for the external audio input signal and the microphone signal.

5. The method according to claim 4, which further comprises determining a similarity between the external audio input signal and the microphone signal from a maximum of the correlation function calculated for the external audio input signal and the microphone signal.

6. The method according to claim 5, which further comprises using a maximum of the cross-correlation exceeding a predetermined threshold value as a criterion for sufficient similarity between the external audio input signal and the microphone signal.

7. A hearing device, comprising:
at least one microphone for detecting airborne sound and converting the airborne sound into a microphone signal;
an audio signal input for receiving an external audio input signal, being separate from the microphone signal; and
a signal processor being configured to:
generate an output signal on a basis of at least one of the microphone signal or the external audio input signal; and
at least additionally attenuate the external audio input signal in a predetermined band of low frequencies and use the attenuated external audio input signal to generate the output signal, in response to receiving the external audio input signal and depending on a decision made at least one of automatically or by a user in connection with receiving the external audio input signal.

8. The hearing device according to claim 7, wherein the external audio input signal is an electromagnetic signal, and said audio signal input includes an antenna for receiving the external audio input signal.

9. The hearing device according to claim 7, wherein the hearing device is an open-ear hearing device for the user.
